(19) United States
(12) Patent Application Publication
(10) Pub. No.: US 2018/0023835 A1
(43) Pub. Date: Jan. 25, 2018

(54) EXPANSION VALVE DEVICE

(71) Applicant: DENSO CORPORATION, Kariya-city, Aichi-pref. (JP)

(72) Inventors: Mitsuo OOURA, Kariya-city (JP); Tatsuhiro MATSUKI, Kariya-city (JP); Tetsuya ITOU, Kariya-city (JP)

(21) Appl. No.: 15/549,936

(22) PCT Filed: Mar. 10, 2016
(86) PCT No.: PCT/JP2016/001320

§ 371 Date: Aug. 9, 2017

(30) Foreign Application Priority Data
Mar. 11, 2015 (JP) 2015-048775

(51) Int. Cl. F24F 11/00; F25B 41/06

(52) U.S. Cl. CPC F24F 11/0012; F25B 41/062; F16K 31/04

(57) ABSTRACT

An expansion valve device has a housing, a valve body, an actuator, a first, second, and third detectors, and a controller. The housing defines a first refrigerant path and a second refrigerant path therein. The first detector detects a temperature of the refrigerant flowing in the first refrigerant path. The second detector detects a temperature and a pressure of the refrigerant flowing on an upstream side of the valve body in the second refrigerant path. The third detector detects a temperature or a pressure of the refrigerant flowing on a downstream side of the valve body in the second refrigerant path. The controller calculates a flow rate of the refrigerant flowing in the second refrigerant path and a superheating degree of the refrigerant flowing in the first refrigerant path, and controls the opening degree of the valve body such that the superheating degree falls within a specified range.

### CROSS REFERENCE TO RELATED APPLICATION

This application is based on Japanese Patent Application No. 2015-048775 filed on Mar. 11, 2015, the disclosure of which is incorporated herein by reference.

### TECHNICAL FIELD

The present disclosure relates to an electric expansion valve device that is disposed in a refrigeration cycle and is capable of decompressing and expanding refrigerant circulating in the refrigeration cycle.

### BACKGROUND ART

A flow rate Gr (kg/s) of refrigerant flowing in a refrigeration cycle is calculated using the following formula F1.

Gr=C×A×(ΔP/ρ)̂0.5 (F1)

C represents a flow rate coefficient (dimensionless), A represents an opening area (m²) of an expansion valve, ΔP represents a pressure difference (Pa) between an upstream side and a downstream side of the expansion valve, and ρ represents a refrigerant density (kg/m³) of refrigerant in an inlet of the expansion valve.

Patent Literature 1 discloses a refrigerant flow meter using the formula F1. The refrigerant flow meter has a pressure sensor and a temperature sensor located upstream of an expansion valve and has the pressure sensor or the temperature sensor downstream of the refrigerant flow meter. The pressure difference and the refrigerant density are calculated using detection values of the sensors. The flow rate is determined using the formula F1 with a valve opening degree of the actuator. The pressure sensor and the temperature sensor are also disposed in an outlet pipe of a condenser such that a superheating degree is controlled simultaneously.

### PRIOR ART LITERATURES

### Patent Literature

Patent Literature 1: JP H5-65779 B2

### SUMMARY OF INVENTION

According to studies conducted by the inventors of the present disclosure, the refrigerant flow meter disclosed in Patent Literature 1 has the pressure sensor or the temperature sensor located on the upstream side and the downstream side of the expansion valve, such that a pressure of the refrigerant is detected directly or estimated. Therefore, accuracy in calculation of the superheating degree and accuracy in detection of the flow rate may deteriorate due to an influence of outside temperature.

In addition, since the pressure sensor or the temperature sensor is attached to pipes, mountability may deteriorate, and a quantity of attachment members may increase.

Moreover, the accuracy in detection of the flow rate may deteriorate when an error is caused, due to a noise, in one of the pressure sensors located upstream and downstream of the expansion valve respectively.

The present disclosure addresses the above-described issues, and it is an objective of the present disclosure to provide an expansion valve device that can detect a flow rate with high accuracy and that can be reduced in size.

An expansion valve device of the present disclosure is disposed in a refrigeration cycle and is capable of decompressing and expanding refrigerant circulating in the refrigeration cycle. The expansion valve device has a housing, a valve body, an actuator, a first detector, a second detector, a third detector, and a controller. The housing defines a first refrigerant path and a second refrigerant path therein. Refrigerant flows from an evaporator to a compressor through the first refrigerant path. Refrigerant flows from a condenser to the evaporator through the second refrigerant path. The valve body is located in the housing and changes an opening area of the second refrigerant path. The actuator actuates the valve body. The first detector detects a temperature of the refrigerant flowing in the first refrigerant path. The second detector detects a temperature and a pressure of the refrigerant flowing on an upstream side of the valve body in the second refrigerant path. The third detector detects a temperature or a pressure of the refrigerant flowing on a downstream side of the valve body in the second refrigerant path. The controller controls the actuator based on detection values detected by the first detector, the second detector, and the third detector to adjust an opening degree of the valve body. The controller (i) performs a calculation calculating a flow rate of the refrigerant flowing in the second refrigerant path using the detection values detected by the second detector and the third detector, (ii) calculates a superheating degree of the refrigerant flowing in the first refrigerant path using the detection value detected by the first detector, and (iii) controls the opening degree of the valve body such that the superheating degree falls within a specified range.

According to the present disclosure, the detectors are attached to the housing of the expansion valve device. As a result, mountability can be improved as compared to a case where the detectors are attached to a pipe connected to the expansion valve device. In addition, since the expansion valve device has the detectors, outside temperature has less effect on detection accuracy as compared to the case where the detectors are attached to the pipe. Accordingly, the flow rate of the refrigerant can be detected with high accuracy.

Furthermore, the controller calculates both the flow rate of the refrigerant flowing in the second refrigerant path and the superheating degree of the refrigerant flowing in the first refrigerant path using the detection values detected by the detectors. Therefore, calculations for controlling the refrigeration cycle can be aggregated to the expansion valve device.

### BRIEF DESCRIPTION OF DRAWINGS

The above and other objects, features and advantages of the present disclosure will become more apparent from the following detailed description made with reference to the accompanying drawings.

FIG. 1 is a diagram illustrating a refrigeration cycle according to a first embodiment.

FIG. 2 is a flow chart showing a calculation process of a flow rate of refrigerant.

FIG. 3 is a diagram illustrating a refrigeration cycle according to a second embodiment.

FIG. 4 is a p-h diagram showing a relationship between an enthalpy and a pressure of refrigerant.

### DESCRIPTION OF EMBODIMENTS

Embodiments of the present disclosure will be described hereinafter referring to drawings. In the embodiments, a part that corresponds to a matter described in a preceding embodiment may be assigned with the same reference number, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

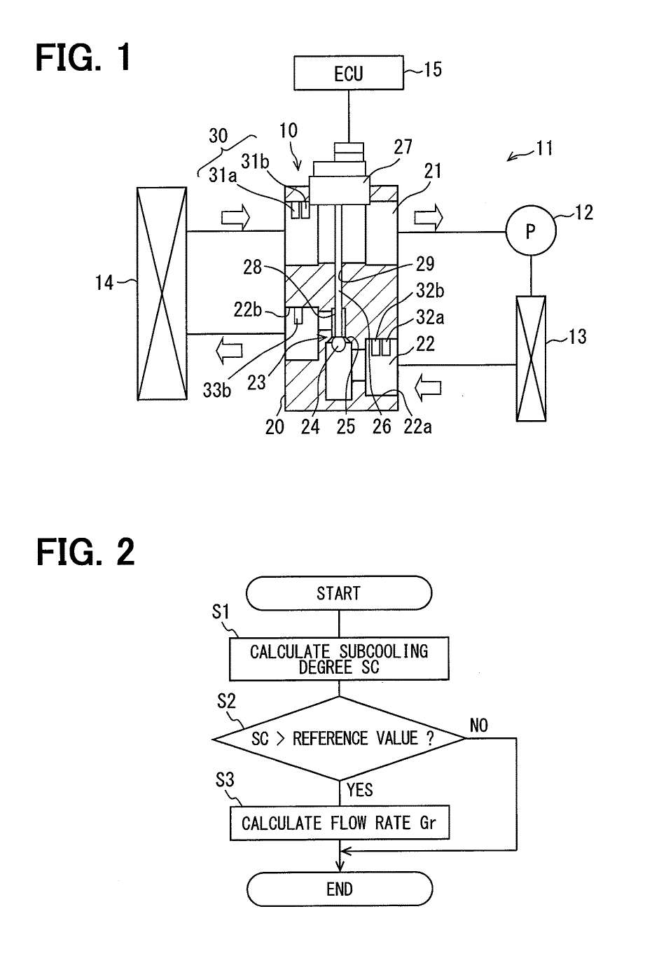

A first embodiment will be described hereafter referring to FIG. 1 and FIG. 2. An expansion valve device 10 is an electric expansion valve device that functions as a decompression device for a refrigeration cycle 11 of an air conditioner for a vehicle etc. The refrigeration cycle 11 has a compressor 12, a condenser 13, the expansion valve device 10 and an evaporator 14. Refrigerant circulates in the refrigeration cycle 11. A controller (i.e., ECU) 15 is disposed in the refrigeration cycle 11 and controls the compressor 12 and the expansion valve device 10.

The compressor 12 has an actuation motor (not shown) therein and is rotary driven by the actuation motor. The compressor 12 is an electric refrigerant compressor that compresses refrigerant, which flows from the evaporator 14 and is drawn by the compressor 12, to have a high temperature and a high pressure and discharges the refrigerant. The high pressure is, for example, a pressure higher than or equal to a critical pressure. The condenser 13 exchanges heat with a refrigerant gas flowing from the compressor 12 and radiates the heat to air.

The expansion valve device 10 is the decompression device that is capable of decompressing and expanding the refrigerant flowing out of the condenser 13 depending on an opening degree of a valve. Specifically, the expansion valve device 10 is configured by an electric expansion valve (EVH) of which opening degree is electrically controlled by the ECU 15.

The evaporator 14 performs a heat exchange between the refrigerant, a pressure of which is reduced by the expansion valve device 10, and air to evaporate the air, and supplies the refrigerant gas to the compressor 12.

The ECU 15 includes CPU performing a control process and a calculation process, a memory such as ROM and RAM storing various programs and data, and I/O port. The ECU therein has a microcomputer having a well-known configuration. The ECU 15, when being energized, electrically controls various actuators for the air conditioner based on operation signals from various devices connected to the ECU 15, sensor signals from various sensor, and control programs stored in the memory.

The expansion valve device 10 will be described hereafter. As shown in FIG. 1, the expansion valve device 10 has a housing 20 having a rectangular columnar shape. The housing 20 is made of metal, e.g., aluminum. The housing 20 therein defines a first refrigerant path 21 through which the refrigerant flows from the evaporator 14 to the compressor 12 and a second refrigerant path 22 through which the refrigerant flows from the condenser 13 to the evaporator 14. Specifically, the first refrigerant path 21 is located between an outlet of the evaporator 14 and an inlet of the compressor 12, and vapor refrigerant (i.e., a low-pressure refrigerant) flows through the first refrigerant path 21. The second refrigerant path 22 is located between an outlet of the condenser 13 and an inlet of the evaporator 14, and liquid refrigerant flows through the second refrigerant path 22. The first refrigerant path 21 and the second refrigerant path 22 are distanced from each other in an up-down direction and extend in a left-right direction on a condition of being illustrated in FIG. 1.

The second refrigerant path 22 has an orifice 23 that expands the liquid refrigerant flowing from the condenser 13. The orifice 23 is a narrow path defined in the second refrigerant path 22 and having a small cross-sectional area. The orifice 23 extends along an axial direction of a valve member 26. An inlet of the orifice 23 is provided is a valve seat 25. A valve body 24 supported by the valve member 26 fits to or distanced from the valve seat 25. Accordingly, the valve body 24 changes an opening area of the second refrigerant path 22. Specifically, a flow rate of the refrigerant passing through the orifice 23 is adjusted by adjusting a distance between the valve body 24 and the valve seat 25.

The valve body 24 and the valve member 26 are integrally fixed to each other by a method such as welding. The valve member 26 has an elongated shape. An upper end of the valve member 26 is connected to an actuator 27, and a lower end of the valve member 26 is connected to the valve body 24.

The second refrigerant path 22 extends from a second refrigerant inlet 22a, into which the liquid refrigerant from the condenser 13 flows, to a second refrigerant outlet 22b. A valve chamber 28 communicating with the second refrigerant inlet 22a is provided in the second refrigerant path 22. The valve chamber 28 is provided concentrically with a center axis of the orifice 23.

The housing 20 further defines a hole 29 therein. The hole 29 is an extension of the orifice 23 and extends in the up-down direction concentrically with the orifice 23. The hole 29 communicates with the first refrigerant path 21. The valve member 26 is located to pass through the hole 29.

The actuator 27 is attached to an upper end of the housing 20. The actuator 27 electrically actuates the valve body 24. The ECU 15 controls an operation of the actuator 27. The actuator has a motor (not shown) such as a stepping motor and a converter (not shown) that converts a rotational force of the motor into a sliding movement of the valve body 24. The converter has a cylindrical male screw that has an outer surface provided with a male thread. The motor has a rotor having a body provided with a female thread. The male thread and the female thread screw together, thereby the rotor moves in an axial direction (i.e., the up-down direction in FIG. 1) when the rotor rotates. When the rotor rotates and moves in the axial direction, the valve member 26 being caught by the body of the rotor moves together with the rotor, and thereby changing the distance between the valve body 24 and the valve seat 25.

Sensors disposed in the first refrigerant path 21 and the second refrigerant path 22 will be described hereafter. According to the present embodiment, a first temperature sensor 31a and a first pressure sensor 31b are disposed in the first refrigerant path 21 as a first detector. The first temperature sensor 31a detects a temperature of the refrigerant flowing in the first refrigerant path 21. The first pressure sensor 31b detects a pressure of the refrigerant flowing in the first refrigerant path 21.

A second temperature sensor 32a and a second pressure sensor 32b are disposed in the second refrigerant path 22 as a second detector and respectively detect a temperature and a pressure of the refrigerant flowing on an upstream side of the valve body 24 in the second refrigerant path 22. The upstream side of the valve body 24 in the second refrigerant path 22 is an upstream side of the valve body 24 in a flow direction of the refrigerant and adjacent to the condenser 13. A third pressure sensor 33b is disposed in the second refrigerant path 22 and detects a pressure of the refrigerant flowing on a downstream side of the valve body 24. The downstream side of the valve body 24 in the second refrigerant path 22 is a downstream side of the valve body 24 in the flow direction of the refrigerant and adjacent to the evaporator 14.

The sensors disposed in the first refrigerant path 21 and the second refrigerant path 22 output detected information to the ECU 15. The ECU 15 is a controller and calculates a flow rate Gr (kg/s) of the refrigerant flowing in the second refrigerant path 22 using detection values detected by the second temperature sensor 32a, the second pressure sensor 32b, and the third pressure sensor 33b. Specifically, the flow rate Gr (kg/s) is calculated using the following formula F2.

Gr=C×A×(ΔP1/ρ)̂0.5 (F2)

C represents a flow rate coefficient (dimensionless), A represents an opening degree (m²) of the valve body 24, ΔP1 represents a pressure difference (Pa) between the upstream side and the downstream side of the valve body 24, and ρrepresents a refrigerant density (kg/m³). The flow rate coefficient C is a known value. The opening degree A is a known value relating to an opening degree of the expansion valve device 10. The pressure difference ΔP1 is a difference between a detection value detected by the second pressure sensor 32b and a detection value detected by the third pressure sensor 33b. The refrigerant density ρ can be calculated using the pressure of the refrigerant detected by the second pressure sensor 32b and the temperature of the refrigerant detected by the second temperature sensor 32a. Thus, the flow rate Gr of the refrigerant can be calculated using the formula F2.

The ECU 15 further calculates a superheating degree of the refrigerant flowing in the first refrigerant path 21 using detection values detected by the first temperature sensor 31a and the first pressure sensor 31b. The superheating degree figures an excess degree of a temperature of the refrigerant gas exceeding a saturation temperature under a specified pressure. Accordingly, the first pressure sensor 31b detects the pressure first, and then a saturation pressure is converted into a temperature using a pressure-temperature phase diagram, so as to calculate the superheating degree. Then, the first temperature sensor 31a detects a temperature of the refrigerant at the same location as the first pressure sensor 31b, and a difference between the above-described converted temperature and the temperature detected by the first temperature sensor 31a is calculated. The difference is the superheating degree.

It is determined whether the flow rate of the refrigerant flowing into the evaporator 14 is appropriate based on the superheating degree. For example, when the superheating degree is extremely high, the flow rate of the refrigerant is too small to perform a cooling operation effectively, and thereby energetic efficiency deteriorates. In contrast, when the superheating degree is extremely low, the flow rate of the refrigerant is too large, and a counter flow of the refrigerant may be caused. It means that the compressor 12 may be damaged. Then, the ECU 15 controls the opening degree of the valve body 24 such that the superheating degree falls within a specified range. As a result, the pressure of the refrigerant is reduced such that the refrigerant is evaporated with an appropriate superheating degree.

A process regarding a subcooling degree SC will be described hereafter referring to FIG. 2. The ECU 15 runs the process shown in FIG. 2 repeatedly during a short amount of time to monitor the subcooling degree SC. The subcooling degree SC is calculated at 51. Specifically, the ECU 15 calculates the subcooling degree SC of the refrigerant flowing on the upstream side of the valve body 24 in the second refrigerant path 22 using the detection values detected by the second temperature sensor 32a and the second pressure sensor 32b. The subcooling degree SC is a difference between a saturation temperature (i.e., a boiling temperature) of the refrigerant and a temperature of the liquid refrigerant. The flow advances to S2 after calculating the subcooling degree SC.

The subcooling degree SC is compared with a reference value at S2. When the subcooling degree SC is larger than the reference value, the flow advances to S3. When the subcooling degree SC is not larger than the reference value, e.g., the supercooling degree SC is lower than or equal to the reference value, the flow ends. The refrigerant is determined whether to be the liquid refrigerant based on the reference value. The refrigerant is determined to be the liquid refrigerant when the subcooling degree SC is larger than the reference value. That is, the flow rate Gr of the liquid refrigerant is calculated at S3. The flow ends after calculating the flow rate Gr at S3.

The flow rate Gr is not calculated when the supercooling degree SC is out of the specified range, i.e., when the supercooling degree SC is lower than or equal to the reference value. The reason of skipping a calculation of the flow rate is that the refrigerant density cannot be calculated since the refrigerant is in a gas-liquid two phase state when the subcooling degree SC (i.e., a subcool) is small. Then, as shown in FIG. 2, the subcooling degree SC is monitored such that the flow rate Gr of only the liquid refrigerant is detected. According to the present embodiment, the flow ends after calculating the flow rate Gr at S3 when the subcooling degree SC is determined to be larger than the reference value (S2: YES). The process of S3 is skipped and the flow ends when the supercooling degree SC is determined to be smaller than or equal to the reference value at S2 (S2: NO). However, the flow rate Gr may be calculated and determined to be an error value (i.e., an incorrect value) when the supercooling degree SC is determined to be smaller than or equal to the reference value at S2.

As described above, the expansion valve device 10 of the present embodiment has the housing 20, and the various sensors 31a, 31b, 32a, 32b, 33b (that will be referred to as the sensors 30 hereafter) are disposed in the housing 20. Since the sensors 30 are attached to the expansion valve device 10, mountability can be improved as compared to a conventional configuration in which the sensors 30 are attached to a pipe connected to the expansion valve device 10. In addition, since the sensors 30 are disposed in the expansion valve device 10, outside temperature has less effect on detection accuracy as compared to the conventional configuration. As a result, the flow rate of the refrigerant can be detected with high accuracy. In other words, since the sensors 30 are arranged inside the expansion valve device 10, the outside temperature has no effect on the sensors 30, a detection error due to a disturbance can be reduced, and thereby detection accuracy can be improved.

It is difficult to attach the sensors 30 to the pipe in view of workability, the detection accuracy, and an easiness of attachment. Then, the sensors 30 and the expansion valve device 10 are provided integrally with each other in advance to be a machine/electricity integral body. As a result, mountability can be improved since the sensors 30 are not necessary to be attached to the pipe in a field work. In addition, the detection accuracy varies depending on locations of the sensors 30 when the sensors 30 are attached to the pipe. Then, the sensors 30 are attached to a fixed location in the expansion valve device 10 such that the detection accuracy is prevented from varying depending on the locations, and thereby the detection accuracy can be improved. Moreover, mountability can be improved since there is no restriction in an attachment structure.

When the sensors 30 are attached to the pipe, wirings for sending the detection values are required. An arrangement of the wirings may be restricted tightly. Here, according to the present embodiment, the wirings are arranged integrally with the expansion valve device 10. In addition, since the sensors 30, necessary for controlling the refrigeration cycle 11, is disposed in the expansion valve device 10, the wirings of the sensors 30 can be concentrated. Accordingly, a configuration of the refrigeration cycle 11 can be simplified, and a manufacturing cost can be reduced.

The ECU 15 calculates the superheating degree of the refrigerant flowing in the first refrigerant path 21 and the flow rate Gr of the refrigerant flowing in the second refrigerant path using the detection values detected by the sensors 30. Accordingly, calculations for controlling the refrigeration cycle 11 can be concentrated on the expansion valve device 10. In other words, the sensors 30 for detecting the flow rate and controlling the superheating degree are arranged in the expansion valve device 10 all together. As a result, a quantity of components is reduced, and thereby both a manufacturing cost and a size of the expansion valve device 10 can be reduced.

According to the present embodiment, the ECU 15 can control a pressure in the compressor 12 since the second pressure sensor 32b is disposed in the second refrigerant path 22. In addition, the ECU 15 further controls the superheating degree. Since the ECU 15 controls both the pressure in the compressor 12 and the supercooling degree, thereby controlling a whole of the refrigeration cycle 11. As a result, cycle efficiency of the refrigeration cycle 11 can be improved.

According to the present embodiment, the second pressure sensor 32b and the third pressure sensor 33b detect the pressures of the refrigerant on the upstream side and the downstream side of the valve body 24 in the second refrigerant path 22 respectively. That is, the second pressure sensor 32b and the third pressure sensor 33b are located in the same noise environment, i.e., in the second refrigerant path 22. As a result, detection noises of the second pressure sensor 32b and the third pressure sensor 33b can be canceled in a differential processing for determining the pressure difference. Thus, detection accuracy in determining the pressure difference can be improved, and thereby detection accuracy in detecting the flow rate can be improved.

Moreover, according to the present embodiment, the ECU 15 calculates the subcooling degree SC of the refrigerant flowing on the upstream side of the valve body 24 in the second refrigerant path 22. When the subcooling degree SC is out of the specified range, the ECU 15 skips the calculation calculating the flow rate Gr, or performs the calculation calculating the flow rate Gr and determines the flow rate Gr to be an error value (i.e., an incorrect value). Thus, the refrigerant is determined whether to be the liquid refrigerant based on the subcooling degree SC, and a refrigerant detection is performed, so as to avoid a false detection of the flow rate.

### Second Embodiment

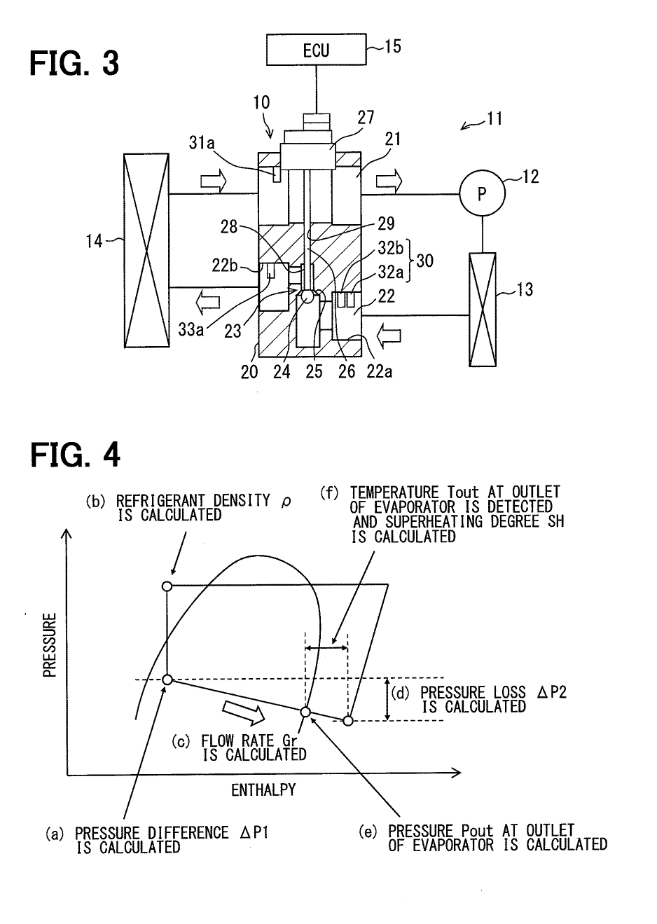

A second embodiment will be described hereafter referring to FIG. 3 and FIG. 4. The present embodiment is different from the first embodiment in points that the first pressure sensor 31b is omitted and that a third temperature sensor 33a is disposed instead of the third pressure sensor 33b. That is, only the first temperature sensor 31a is disposed in the first refrigerant path 21. The third temperature sensor 33a is disposed instead of the third pressure sensor 33b and detects a temperature of the refrigerant flowing on the downstream side of the valve body 24 in the second refrigerant path 22.

The ECU 15 calculates, using a detection value detected by the third temperature sensor 33a, a pressure of the refrigerant flowing on the downstream side of the valve body 24 in the second refrigerant path 22 based on a saturation temperature of gas-liquid two phase refrigerant. Accordingly, the pressure of the refrigerant can be calculated using the detection value detected by the third temperature sensor in a case where the third pressure sensor 33b is not attached. That is, the third pressure sensor 33b may be attached instead of the third temperature sensor 33a, although the third temperature sensor 33a is attached as a third detector according to the present embodiment.

Since the first pressure sensor 31b is omitted according to the present embodiment, a pressure of the refrigerant flowing in the first refrigerant path 21 is required to be calculated for controlling the superheating degree. Then, a method for controlling the superheating degree by calculating the pressure of the refrigerant in the first refrigerant path 21 will be described hereafter referring to FIG. 4.

The pressures of the refrigerant on the upstream side and the downstream side of the valve body 24 in the second refrigerant path 22 are known based on the detection values detected by the second pressure sensor 32b and the third temperature sensor 33a. Specifically, the second pressure sensor 32b detects the pressure of the refrigerant on the upstream side of the valve body 24 in the second refrigerant path 22. The pressure of the refrigerant on the downstream side of the valve body 24 in the second refrigerant path 22 is calculated based on the detection value detected by the third temperature sensor 33a. The pressure difference ΔP1 is calculated at a point (a) shown in FIG. 4. The pressure difference ΔP1 is a difference between a pressure on the upstream side of the valve body 24 in the second refrigerant path 22 (i.e., in the inlet of the second refrigerant path 22) and a pressure on the downstream side of the valve body 24 in the second refrigerant path 22 (i.e., in the outlet of the second refrigerant path 22).

The refrigerant density ρ is calculated at a point (b) shown in FIG. 4. The refrigerant density ρ is calculated using the detection values detected by the second pressure sensor 32b and the second temperature sensor 32a. The second pressure sensor 32b and the second temperature sensor 32a are located at substantially the same location on the upstream side of the valve body 24 in the second refrigerant path 22.

The flow rate Gr of the refrigerant is calculated at a point (c) shown in FIG. 4. The flow rate Gr is calculated based on the following formula F3 using the pressure difference ΔP1 calculated at the point (a), the refrigerant density ρ calculated at the point (b), and the opening degree A.

Gr=C×A×(2×ΔP1/ρ)̂0.5 (F3)

A pressure loss ΔP2 in the evaporator 14 is calculated at a point (d) shown in FIG. 4. The pressure loss ΔP2 is calculated using the following formula F4 that shows a correlation between the flow rate Gr calculated at the point (c) and the pressure loss ΔP2. In other words, when the flow rate Gr is determined, the pressure loss ΔP2 in the evaporator 14 can be calculated using the formula F4.

ΔP2=f(Gr) (F4)

A pressure Pout of the refrigerant at the outlet of the evaporator 14 is calculated at a point (e) shown in FIG. 4. The pressure Pout can be calculated by subtracting the pressure loss ΔP2 calculated at the point (d) from a pressure Pin of the refrigerant in the second refrigerant outlet 22b located on the downstream side of the valve body 24 in the second refrigerant path 22.

Pout=Pin−ΔP2 (F5)

The pressure Pout at the outlet of the evaporator 14 calculated using the formula F5 is a pressure of the refrigerant flowing in the first refrigerant path 21. Accordingly, the pressure in the first refrigerant path 21 can be calculated without using the first pressure sensor 31b.

The superheating degree can be controlled based on the pressure Pout at the outlet of the evaporator 14 calculated as described above. Specifically, the pressure Pout in the first refrigerant path 21 calculated at the point (e) is converted to a temperature T using a pressure-temperature diagram at a point (f) shown in FIG. 4. Then, the superheating degree SH is calculated using the following formula F6 based on a temperature Tout in the first refrigerant path 21 detected by the first temperature sensor 31a. The temperature Tout in the first refrigerant path 21 is, i.e., the temperature at the outlet of the evaporator 14.

SH=Tout−T (F6)

Thus, although the first pressure sensor 31b used for controlling the superheating degree is not disposed in the first refrigerant path 21 according to the present embodiment, the pressure of the refrigerant in the first refrigerant path 21 can be calculated using other detection values and correlations thereof. As a result, the quantity of components can be further reduced as compared to the first embodiment, and thereby further reducing the manufacturing cost. In other words, the superheating degree can be controlled, and the flow rate can be detected with high accuracy, at the same time of reducing the manufacturing cost and the size of the expansion valve device 10 by omitting the first pressure sensor 31b.

(Modifications)

While the present disclosure has been described with reference to preferred embodiments thereof, it is to be understood that the disclosure is not limited to the preferred embodiments and constructions. The present disclosure is intended to cover various modification and equivalent arrangements within a scope of the present disclosure.

It should be understood that structures described in the above-described embodiments are preferred structures, and the present disclosure is not limited to have the preferred structures. The scope of the present disclosure includes all modifications that are equivalent to descriptions of the present disclosure or that are made within the scope of the present disclosure.

According to the above-described first embodiment, the refrigeration cycle 11 is used for the air conditioner for a vehicle. However, the air conditioner is not limited to be used for a vehicle. For example, the air conditioner may be a household air conditioner or a professional-use air conditioner for an industrial plant, premises, or the like.

According to the above-described first embodiment, the ECU 15 is provided separately from the expansion valve device 10. However, the ECU 15 for controlling the expansion valve device 10 may be provided integrally with the expansion valve device 10. In the case where the ECU 15 and the expansion valve device 10 are provided integrally with each other, another controller for controlling a whole of the air conditioner may be required separately from the ECU 15.

What is claimed is:

1. An expansion valve device that is disposed in a refrigeration cycle and is capable of decompressing and expanding refrigerant circulating in the refrigeration cycle, the expansion valve device comprising:
a housing that defines a first refrigerant path and a second refrigerant path therein, the first refrigerant path through which refrigerant flows from an evaporator to a compressor, the second refrigerant path through which refrigerant flows from a condenser to the evaporator;
a valve body located in the housing and changing an opening area of the second refrigerant path;
an actuator actuating the valve body;
a first detector that detects a temperature of the refrigerant flowing in the first refrigerant path;
a second detector that detects a temperature and a pressure of the refrigerant flowing on an upstream side of the valve body in the second refrigerant path;
a third detector that detects a temperature or a pressure of the refrigerant flowing on a downstream side of the valve body in the second refrigerant path; and
a controller that controls the actuator based on detection values detected by the first detector, the second detector, and the third detector to adjust an opening degree of the valve body, wherein
the controller
performs a calculation calculating a flow rate of the refrigerant flowing in the second refrigerant path using the detection values detected by the second detector and the third detector,
calculates a superheating degree of the refrigerant flowing in the first refrigerant path using the detection value detected by the first detector, and
controls the opening degree of the valve body such that the superheating degree falls within a specified range.

2. The expansion valve device according to claim 1, wherein
the third detector detects the pressure of the refrigerant flowing on the downstream side of the valve body in the second refrigerant path.

3. The expansion valve device according to claim 1, wherein
the controller calculates a pressure of the refrigerant flowing in the first refrigerant path using the detection value detected by the third detector and the flow rate.

4. The expansion valve device according to claim 1, wherein
the controller
calculates a subcooling degree of the refrigerant flowing on the upstream side of the valve body in the second refrigerant path using the detection value detected by the second detector and
skips the calculation calculating the flow rate, or performs the calculation calculating the flow rate and determines the flow rate to be an error value, when the subcooling degree is out of a specified range.

5. The expansion valve device according to claim 1, wherein
the first detector is capable of detecting a pressure of the refrigerant flowing in the first refrigerant path, and
the superheating degree is calculated using the detection values of the temperature and the pressure detected by the first detector.
